(19) United States
(12) Patent Application Publication
(10) Pub. No.: US 2017/0008159 A1
(43) Pub. Date: Jan. 12, 2017

(54) Machine Tool Device

(71) Applicant: ROBERT BOSCH GMBH, Stuttgart (DE)

(72) Inventors: Cornelius Boeck, Kirchheim (DE); Daniel Barth, Leinfelden-Echterdingen (DE); Joachim Schadow, Stuttgart (DE); Joerg Maute, Sindelfingen (DE); Florian Esenwein, Leinfelden-Echterdingen (DE); Manfred Lutz, Filderstadt (DE); Joern Stock, Bempflingen (DE)

(21) Appl. No.: 15/114,282

(22) PCT Filed: Dec. 29, 2014
(86) PCT No.: PCT/EP2014/079360

§ 371 Date: Jul. 26, 2016

(30) Foreign Application Priority Data
Jan. 27, 2014 (DE) 10 2014 201 371.2
May 13, 2014 (DE) 10 2014 208 980.8

(51) Int. Cl. B25F 5/00; G05B 9/03; B23Q 11/00

(52) U.S. Cl. CPC B25F 5/00; B23Q 11/0082; B23Q 11/0085; G05B 9/03

(57) ABSTRACT

The disclosure relates to a machine tool device, in particular a handheld machine tool device, comprising at least one control and/or regulating unit and at least one drive unit sensor unit for detecting at least one drive unit parameter that can be processed at least in order to control and/or regulate a drive unit of a machine tool and/or in order to output information to an operator of the control and/or regulating unit. According to the disclosure, the machine tool device comprises at least one operator sensor unit in order to detect at least one operator-specific parameter that can be processed at least in order to control and/or regulate the drive unit and/or in order to output information to an operator of the control and/or regulating unit.

### PRIOR ART

US 2013/0187587 A1 already discloses a power tool device, in particular a handheld power tool device, which comprises an open-loop and/or closed-loop control unit and a drive unit sensor unit for recording at least one drive unit characteristic variable, wherein the drive unit characteristic variable can be processed by the open-loop and/or closed-loop control unit for providing an open-loop and/or closed-loop control of a drive unit of a power tool and/or for providing an output of information to an operator.

### DISCLOSURE OF THE INVENTION

The invention is based on a power tool device, in particular on a handheld power tool device, with at least one open-loop and/or closed-loop control unit and with at least one drive unit sensor unit for recording at least one drive unit characteristic variable, which can be processed by the open-loop and/or closed-loop control unit at least for providing an open-loop and/or closed-loop control of a drive unit of a power tool and/or for providing an output of information to an operator.

It is proposed that the power tool device comprises at least one operator sensor unit for recording at least one operator-specific characteristic variable, which can be processed by the open-loop and/or closed-loop control unit at least for providing an open-loop and/or closed-loop control of the drive unit and/or for providing an output of information to an operator. The open-loop and/or closed-loop control unit is at least preferably intended for controlling the drive unit in an open-loop and/or closed-loop manner in dependence on the at least one drive unit characteristic variable recorded by the drive unit sensor unit and in dependence on the at least one operator-specific characteristic variable recorded by means of the operator sensor unit. In addition, the open-loop and/or closed-loop control unit is preferably intended at least for outputting to an operator information in dependence on the at least one drive unit characteristic variable recorded by means of the drive unit sensor unit and in dependence on the at least one operator-specific characteristic variable recorded by means of the operator sensor unit. Preferably, at least one drive unit characteristic curve, a maximum rotational speed, a minimum rotational speed, a maximum torque and/or a minimum torque of the drive unit can be controlled in an open-loop and/or closed-loop manner by means of the open-loop and/or closed-loop control unit.

An “open-loop and/or closed-loop control unit” is to be understood in particular as meaning a unit with at least one set of control electronics. “Control electronics” is to be understood in particular as meaning a unit with a processor unit and with a memory unit and also with an operating program stored in the memory unit. “Intended” is to be understood in particular as meaning specifically programmed, specifically designed and/or specifically equipped. Saying that an element and/or a unit is/are intended for a specific function is to be understood in particular as meaning that the element and/or the unit fulfills/fulfill and/or performs/perform this specific function in at least one application state and/or operating state.

The drive unit sensor unit is preferably intended for recording at least one drive unit characteristic variable of a drive unit formed as an electric motor unit, in particular as a brushless electric motor unit. Consequently, the drive unit sensor unit is preferably formed as an EC electric motor drive unit sensor unit. The drive unit characteristic variable may be formed here as a drive unit current, as a drive unit voltage, as a drive unit angle of rotation, as an electrical drive unit resistance, as a drive unit magnetic field characteristic variable, as an electromotive force characteristic variable of the drive unit, as a drive unit rotational speed, as a drive unit torque, as a drive unit angular velocity, as a drive unit rotor position, as a drive unit direction of rotation, as a drive unit temperature or as a further drive unit characteristic variable that appears appropriate to a person skilled in the art. The drive unit characteristic variable is preferably different from a straightforward switch actuation of a switch by an operator. The drive unit sensor unit comprises at least one drive unit sensor element for recording the at least one drive unit characteristic variable. The drive unit sensor element may be formed here as a drive unit current sensor, as a drive unit voltage sensor, as a drive unit angle of rotation sensor, as an electrical drive unit resistance sensor, as a drive unit magnetic field sensor, as an electromotive force characteristic variable sensor, as a drive unit rotational speed sensor, as a drive unit torque sensor, as a drive unit angular speed sensor, as a drive unit rotor position sensor, as a drive unit direction of rotation sensor, as a drive unit temperature sensor or as a further drive unit sensor element that appears appropriate to a person skilled in the art.

An information output unit for providing an output of information to an operator is preferably formed as an optical, acoustic and/or haptic information output unit. Here, the information output unit is preferably a component part of the power tool device. It is however also conceivable that the information output unit is a component part of a power tool comprising the power tool device or a component part of an external unit, such as for example a smartphone, a tablet, a PC, a laptop or the like. For providing an output of information to an operator, the information output unit preferably comprises at least one optical output unit, such as for example an LC display, a touch-sensitive display, an LED display, a plasma display or the like for providing an optical output of information to an operator. Preferably, the information output unit comprises at least one acoustic output unit, such as for example a loudspeaker or the like, for providing an acoustic output of information to an operator. Particularly preferably, the information output unit comprises at least one haptic output unit, such as for example a vibration exciter unit or the like, for providing a haptic output of information to an operator. It is however also conceivable that an output of information to an operator takes place as a result of an activation of the drive unit by means of the open-loop and/or closed-loop control unit. It is conceivable here that an output of information to an operator takes place for example due to a fluctuation in rotational speed of a drive unit rotational speed or the like. Further drive-unit-related information outputs to an operator that appear appropriate to a person skilled in the art are likewise conceivable.

An “operator-specific characteristic variable” is to be understood in particular as meaning here a characteristic variable that is dependent on an operator itself, such as for example a level of training of an operator, a safe standing position of an operator, fatigue of an operator, a physical state of an operator etc., and/or that is dependent on a behavior of an operator, such as for example a behavior of an operator when using a power tool comprising the power tool device, a way in which an operator affects the power tool device, in particular a way in which an operator affects a power tool comprising the power tool device, etc. The operator-specific characteristic variable may be formed here as an operator pressing force, as an operator advancing force, as an operator training status, as an operator holding force, as an operator-specific type of exposure to stress, as an operator application case, as an operator pressing pressure, as a degree of operator use, such as for example a characteristic variable describing frequent use or infrequent use, as a time of operator use, as operator exposure to stress, such as for example exposure to noise and/or exposure to vibration, as operator access authorization to a location, as a body characteristic variable of an operator, such as for example a body temperature, a pulse of an operator, a fatigue characteristic variable of an operator, a position of at least one hand of the operator, etc., or as some other operator-specific characteristic variable that appears appropriate to a person skilled in the art.

On the basis of the operator-specific characteristic variable, moreover, particularly preferably safety functions, in particular safety functions of a power tool comprising the power tool device and/or safety functions of power tool accessory units that can be arranged on the power tool, can be controlled in an open-loop and/or closed-loop manner by means of the open-loop and/or closed-loop control unit. Here, for example, safety parameters, such as for example a kickback parameter, a maximum torque, a maximum rotational speed, an impact energy, a protective shroud position and/or a slip clutch release moment, can be set for example by means of the open-loop and/or closed-loop control unit. The safety parameters are preferably dependent here on a type of power tool in which the power tool device is used.

By means of the configuration according to the invention, an operator can be advantageously monitored while operating a power tool comprising the power tool device. A protective function can be advantageously set and/or activated in dependence on the operator-specific characteristic variable. Consequently, a risk of an operator being injured and/or of improper operation of a power tool comprising the power tool device can be advantageously kept down. Furthermore, overworking of an operator can be advantageously detected and corresponding measures can be advantageously introduced, such as for example a warning of fatigue, a warning of overworking, a warning of injury, etc. Moreover, allowance can be advantageously made for an operating behavior for providing open-loop and/or closed-loop control of the drive unit. Here it is conceivable for example that a parameter of a start-up behavior is adaptable to the operator-specific characteristic variable, a drive unit characteristic variable is adaptable to the operator-specific characteristic variable, an impact frequency is adaptable to the operator-specific characteristic variable, an impact energy is adaptable to the operator-specific characteristic variable, an orbital stroke parameter is adaptable to the operator-specific characteristic variable or further parameters or characteristic maps of a drive unit that appear appropriate to a person skilled in the art are adaptable to the operator-specific characteristic variable. Moreover, an operator may be advantageously assigned to a user group in order to adapt parameters for providing an open-loop and/or closed-loop control of the drive unit to the operator.

Furthermore, it is proposed that the power tool device comprises at least one communication unit for communication with at least one external unit for an exchange of electronic data at least for providing an open-loop and/or closed-loop control of the drive unit. The communication unit is preferably formed as a cableless communication unit. Here, the communication unit may be formed as a WLAN communication unit, as a Bluetooth communication unit, as a radio communication unit, as an RFID communication unit, as an NFC unit, as an infrared communication unit, as a mobile radio network communication unit or the like. Particularly preferably, the communication unit is intended for bidirectional data transmission. In an alternative configuration, the communication unit is formed as a cable-bound communication unit, such as for example as an LAN communication unit, as a USB communication unit or the like. The external unit is preferably formed as a smartphone, which has an app for communication with the communication unit. It is however also conceivable that the external unit is formed as an external, transportable operator control unit, as a permanently installed operator control unit at a workplace of an operator, as a place-of-use synchronization unit permanently installed in a room, which can be controlled by a central station, such as for example as a result of company rules/safety regulations, as an operator body characteristic variable monitoring unit or as a further centralized or decentralized operator control unit, input station and/or centralized or decentralized terminal that appears appropriate to a person skilled in the art. Consequently, a synchronization of electronic data can be advantageously made possible. If, for example, a power tool comprising the power tool device is put into operation in a synchronization mode, for example by plugging in a rechargeable battery device, when a power supply cable is plugged in or by activation by an operator, a connection between the communication unit and the external unit is set up at least partially automatically. Settings stored in the external unit are consequently preferably directly transmittable to the power tool comprising the power tool device. These may be individual settings of an operator, such as for example a desired rapid run-up to a set rotational speed and maximum power, company rules, such as for example compliance with a safety function in a designated area of company premises or a place of use, etc. Moreover, a connection of the power tool device and the external unit by means of the communication unit allows a central control of the power tool to be achieved, such as for example a central switching off of the power tool, such as for example in the event of a fire, etc. If a power tool is removed from a designated area, the power tool is preferably deactivated, and consequently cannot be activated outside the designated area.

Moreover, electronic data can be transmitted by means of the communication unit to the external unit. For example, it is possible here to transmit to a company central office or the like an exposure of an operator to vibration, to check whether an exposure limit is being maintained, and/or a possible payment of bonuses and/or a running time and a load, to assess capacity utilization of a power tool. It is also conceivable that the external unit checks for the presence of safety equipment and/or suitable work clothing, such as for example by means of radio frequency identification etc., wherein, in dependence on detected safety equipment and/or suitable work clothing, the external unit transmits settings for providing open-loop and/or closed-loop control of the drive unit and/or safety functions of the power tool comprising the power tool device by way of the communication unit to the open-loop and/or closed-loop control unit. By means of the configuration according to the invention, a convenient, in particular centralized, setting of characteristic variables of a power tool comprising the power tool device can advantageously take place. Moreover, a communication between the open-loop and/or closed-loop control unit and an external unit formed as an operator body characteristic variable monitoring unit and/or some other external unit that appears appropriate to a person skilled in the art can advantageously take place, in order advantageously to control safety functions in an open-loop and/or closed-loop manner. Consequently, a high degree of safety for an operator can be advantageously ensured.

It is further proposed that the open-loop and/or closed-loop control unit is intended for accessing by means of the communication unit a central database, in which there is stored at least one safety and/or operating area rule, which can be processed by the open-loop and/or closed-loop control unit at least for providing an open-loop and/or closed-loop control of the drive unit. Consequently, the open-loop and/or closed-loop control unit is preferably intended for controlling at least the drive unit of the portable power tool in an open-loop and/or closed-loop manner in dependence on at least one safety and/or operating area rule of an area of an infrastructure. Allowance can be made in particular for a location, such as for example a global position, at which the portable power tool is used within the infrastructure. Moreover, it is conceivable that the open-loop and/or closed-loop control unit is intended for controlling further functions of the portable power tool in an open-loop and/or closed-loop manner, such as for example a safety function (kickback function or the like) in dependence on at least one safety and/or operating area rule of an area of an infrastructure. Moreover, it is conceivable that locations, such as for example construction sites, outside the infrastructure are covered by means of a digital safety and/or operating area rule grid on the basis of GPS data, by means of which an assignment of safety and/or operating area rules for a location outside the infrastructure can be achieved.

The term “central database” is to be understood in particular as defining here a database that is maintained and/or managed centrally by a management unit, such as for example by a building management, by a safety management or the like. Data, in particular electronic data, which define specific rules, regulations, risk potentials, safety categories or the like for at least one area of an infrastructure, in particular an area of a works premises, an area of a workshop or the like, are preferably stored in the central database. In an infrastructure, in particular in an infrastructure of a works premises, there are laboratories, workshops, offices or the like, which have different risk potentials. Here, the facility management (FCM) bears responsibility in particular for technical facilities and/or individual areas of the infrastructure. Risk assessments are preferably carried out regularly by health and safety engineers (HSE) for technical facilities and/or for individual areas of the infrastructure. Consequently, individual component parts of the infrastructure, such as for example individual laboratories, individual workshops and/or individual offices, are preferably assigned specific rules, regulations, safety categories or the like. For example, an assignment that stipulates that high to very high safety standards are to be maintained may be performed. Explosion protection may for example apply here in individual areas of the infrastructure, in particular in certain rooms. Consequently, work during which for example sparks may occur is preferably prohibited in these areas, or only certain power tools are allowed to carry out the work. Furthermore, assignments with moderate to low safety standards are conceivable. Moreover, assignments that concern vibration and/or noise limits are additionally or alternatively conceivable.

The central database is preferably updated at regular time intervals, in particular by an employee of the facility management and/or by a health and safety engineer (HSE). This preferably involves risk assessments being carried out for the individual areas of the infrastructure, such as for example for individual rooms, laboratories, workshops or the like. On the basis of these risk assessments, it is possible to store in the central database corresponding electronic data which, in dependence on a degree of risk, stipulate for the individual areas of the infrastructure use and/or operation characteristic variables relating to the use and/or operation of a portable power tool, such as for example compliance with prescribed rules of behavior, presence of personal protective equipment (PPE), establishment of access authorization, an obligation to provide evidence of further training or instruction. By means of the configuration according to the invention, a high level of user safety can consequently be advantageously achieved, since by means of the open-loop and/or closed-loop control unit there is an automatic inclusion of safety and/or operating area rules. Consequently, a location- and/or rule-dependent open-loop and/or closed-loop control of the portable power tool can be advantageously achieved. Moreover, it is conceivable that, in addition or as an alternative to a communication with the central database, there is a communication, in particular a data exchange, with at least one sensor unit of work clothing, in particular personal protection equipment (PPE), that an operator and/or user is wearing. Consequently, a safety function of the portable power tool can be advantageously further enhanced. Particularly advantageously, a dependable detection of hazardous situations can be made possible as a result of an indication, an active warning, a disabling of the portable power tool or the like. Consequently, an operator of the portable power tool can be advantageously protected from dangers and/or from injuries.

The open-loop and/or closed-loop control unit is advantageously intended for detecting, at least in dependence on the at least one operator-specific characteristic variable, operation of the power tool that cannot be controlled by an operator. Here it is possible for example to record the safe standing position of the operator on a ladder, in particular on a rung of a ladder, with at least one sensor element of the operator sensor unit, such as for example by means of at least one pressure sensor element of the operator sensor unit or an external sensor unit that is arranged on an item of clothing and communicates by way of the communication unit with the power tool device. In the event of canting and/or blocking of the machining tool in a workpiece to be worked, a sudden drop in rotational speed can be recorded for example by means of a rotational speed sensor element of a machining tool sensor unit of the power tool device or by means of a rotational speed sensor element of the operator sensor unit. Alternatively or in addition, a kickback or a recoil of the power tool can be recorded by means of an acceleration sensor element of the machining tool sensor unit or by means of an acceleration sensor element of the operator sensor unit. As a result of recording a sudden drop in rotational speed and/or a kickback or a recoil, it is possible by means of the open-loop and/or closed-loop control unit to detect operation of the power tool that cannot be controlled by an operator. Moreover, it is conceivable that an absence of pressure applied by the operator can be recorded by the at least one sensor element of the operator sensor unit, whereby an unsafe standing position and/or an unrestrained fall of the operator can be detected. Furthermore, an unrestrained fall of the power tool for example can be recorded by means of the acceleration sensor element of the machining tool sensor unit or by means of the acceleration sensor element of the operator sensor unit. Consequently, the open-loop and/or closed-loop control unit can detect a fall, such as for example an unrestrained fall, of the operator from the ladder and activate safety functions, such as for example an active deceleration of the machining tool and/or a retraction of the machining tool into a power tool housing, an interruption of a power supply to the drive unit or the like. By means of the configuration according to the invention, a high level of operator safety can be advantageously realized.

In at least one configuration of the power tool device according to the invention, the open-loop and/or closed-loop control unit is intended for outputting at least one emergency signal by means of the communication unit and/or by means of the information output unit at least in dependence on at least one operator-specific characteristic variable recorded by means of the operator sensor unit. If a working accident is detected, an operator is for example requested by means of the information output unit (haptically, optically and/or acoustically) to acknowledge that he is unharmed, such as for example by actuation of an operator control element of the power tool device or of an external unit, such as for example a smartphone, a watch or the like. If such an acknowledgement does not take place within a time period of less than 50 seconds, at least one emergency signal is issued by means of the communication unit and/or by means of the information output unit. Moreover, it is conceivable that, if an emergency call is issued, position data and possibly further information, such as for example the type of accident (a fall, electrocution or the like), a heart rate of the injured operator, etc., are likewise transmitted. Consequently, a high level of operator safety can be advantageously ensured.

The open-loop and/or closed-loop control unit is advantageously further intended for controlling the drive unit in an open-loop and/or closed-loop manner and/or for outputting an item of information at least in dependence on an operator-specific characteristic variable formed as operator exposure to stress. If a personally admissible and/or fixed amount of vibration to which an operator may be exposed is exceeded or reached, the open-loop and/or closed-loop control unit interrupts a power supply to the drive unit and/or outputs information in dependence on the operator-specific characteristic variable formed as an operator vibration exposure level. Power tools that generate a high level of vibration, such as for example demolition hammers, can then no longer be put into operation by the operator. Power tools that generate a low level of vibration, such as for example screwdrivers, can still be put into operation. The amount(s) of vibration to which an operator may be exposed may be accumulated from work with different power tools. Operator vibration exposure data can be stored user-specifically, such as for example in a company network, in a smartphone, in the memory unit of the open-loop and/or closed-loop control unit or the like. The operator-specific characteristic variables formed as an operator vibration exposure level can be recorded for example by means of at least one acceleration sensor element of the operator sensor unit and/or by means of at least one acceleration sensor element of an external unit. The acceleration sensor element(s) may be arranged here on the power tool and/or on the operator, in particular on items of clothing of the operator. By means of the configuration of the power tool device according to the invention, operator-friendly handling of the power tool can be advantageously achieved. Moreover, excessive exposure of an operator to stress can be advantageously avoided.

It is further proposed that the power tool device comprises at least one ambient sensor unit for recording at least one ambient characteristic variable, which can be processed by the open-loop and/or closed-loop control unit at least for providing an open-loop and/or closed-loop control of the drive unit and/or for providing an output of information to an operator. An “ambient sensor unit” is to be understood as meaning in particular here a sensor unit that has at least one ambient sensor element for recording at least one ambient characteristic variable, which defines an environment surrounding the power tool device, defines an impact of the power tool device on the surrounding environment and/or defines a positioning of the power tool device in relation to the surrounding environment. The ambient sensor unit is preferably intended here for recording at least one ambient pressure, an ambient temperature, an ambient sound level, a global position and/or a spatial position of the power tool device. Particularly preferably, the open-loop and/or closed-loop control unit is intended for controlling the drive unit and/or safety functions in an open-loop and/or closed-loop manner in dependence on the at least one ambient characteristic variable recorded by means of the ambient sensor unit and in dependence on electronic data transmitted by means of the communication unit to the open-loop and/or closed-loop control unit. By means of the configuration of the power tool device according to the invention, a high level of operator safety can be advantageously achieved, since for example a spatial alignment of the power tool device and a global position of the power tool device can be used in combination with location-related safety requirements for providing an open-loop and/or closed-loop control of the drive unit and/or of safety functions. Consequently, an operator can be advantageously protected from injuries.

The open-loop and/or closed-loop control unit advantageously adapts at least one parameter stored in a memory unit of the open-loop and/or closed-loop control unit for providing an open-loop and/or closed-loop control of the drive unit at least in dependence on at least one ambient characteristic variable recorded by means of the ambient sensor unit and formed as a global position. For this purpose, the ambient sensor unit preferably comprises at least one GPS sensor element, by means of which a global position of the power tool comprising the power tool device can be recorded. It is however also conceivable that the ambient sensor unit has some other sensor element that appears appropriate to a person skilled in the art for recording an ambient characteristic variable formed as a global position. As a result of a connection to a network, such as for example a company network, an Internet network or the like, the open-loop and/or closed-loop control unit checks by way of the communication unit whether safety settings and/or current climatic data (weather) are stored for the ambient characteristic variable formed as a global position. In the event of rainy weather, for example, the open-loop and/or closed-loop control unit is intended here to carry out a current leakage measurement before supplying current to the drive unit. The stored safety settings may be in particular device adaptations, such as for example a reduction of a maximum rotational speed, an alteration of a kickback sensitivity setting etc., stipulations that some work must not be carried out with certain accessory units, or warnings for an operator, such as for example a warning of the risk of explosion and/or fire due to flying sparks etc. By means of the configuration of the power tool device according to the invention, open-loop and/or closed-loop control parameters can be advantageously adapted to different conditions of use.

It is moreover proposed that the power tool device comprises at least one power tool accessory sensor unit for recording at least one power tool accessory characteristic variable, which can be processed by the open-loop and/or closed-loop control unit at least for providing an open-loop and/or closed-loop control of the drive unit and/or for providing an output of information to an operator. A “power tool accessory sensor unit” is to be understood as meaning in particular here a sensor unit that records a characteristic variable of at least one power tool accessory which can be attached to a power tool comprising the power tool device. The power tool accessory characteristic variable may be formed here as an accessory state characteristic variable, such as for example a mounted state characteristic variable of an accessory, a wear state characteristic variable, as an accessory position characteristic variable, as an accessory function characteristic variable, as an accessory dimension characteristic variable or the like. Consequently, allowance for a mounted accessory can be advantageously made in an open-loop and/or closed-loop control of the drive unit by means of the open-loop and/or closed-loop control unit. For example, in the event of an incorrect, defective and/or worn accessory, an output of information to an operator can advantageously take place and/or an open-loop and/or closed-loop control parameter, such as for example a rotational speed, a power supply, a voltage supply or the like, can be advantageously adapted.

Furthermore, it is proposed that the power tool device comprises at least one machining tool sensor unit for recording at least one machining tool characteristic variable, which can be processed by the open-loop and/or closed-loop control unit at least for providing an open-loop and/or closed-loop control of the drive unit and/or for providing an output of information to an operator. The machining tool sensor unit is preferably intended for recording at least one machining tool characteristic variable of a machining tool arranged in a tool holder. The tool holder is preferably a component part of a power tool comprising the power tool device. It is however also conceivable that the tool holder is a component part of the power tool device. The machining tool characteristic variable may be formed here as a machining tool mass, as a machining tool dimension, as a machining tool vibration, as a machining tool speed, as a machining tool rotational speed, as a machining tool inertia, as a machining tool type, as a machining tool temperature, as a machining tool degree of contamination, as a machining tool cutting edge wear, or as some other machining tool characteristic variable that appears appropriate to a person skilled in the art. The machining tool sensor unit comprises at least one machining tool sensor element for recording the at least one machining tool characteristic variable. The machining tool sensor element may be formed here as a machining tool mass sensor, as a machining tool dimension sensor, as a machining tool vibration sensor, as a machining tool speed sensor, as a machining tool rotational speed sensor, as a machining tool inertia sensor, as a machining tool type sensor, as a machining tool temperature sensor, as a machining tool degree of contamination sensor, as a machining tool cutting edge wear sensor or some other machining tool sensor element that appears appropriate to a person skilled in the art.

Preferably, at least when running up the drive unit to an idling speed, at least one drive unit characteristic variable and/or at least one machining tool characteristic variable can be determined by means of the open-loop and/or closed-loop control unit. Vibrations of a machining tool can preferably be recorded here by means of at least one machining tool sensor element, which is formed as an acceleration sensor, wherein the recorded signals can be evaluated by means of the open-loop and/or closed-loop control unit. Moreover, a machining tool characteristic variable that can be processed by the open-loop and/or closed-loop control unit for providing a determination of a machining tool dimension can preferably be recorded by means of at least one further machining tool sensor element, which is formed as an optical sensor (camera, infrared sensor etc.) or as a distance sensor. Moreover, a motor current can preferably be recorded by means of a drive unit sensor element during running up of the drive unit to an idling speed, which can be processed by means of the open-loop and/or closed-loop control unit for providing a determination of an inertia of a machining tool. Furthermore, a machining tool type of a machining tool can be determined by means of the open-loop and/or closed-loop control unit by means of at least one recorded machining tool characteristic variable, wherein parameters can be changed machining-tool-specifically for providing an open-loop and/or closed-loop control of the drive unit, such as for example a setting of a rotational speed for stainless steel applications when a stainless steel machining tool is detected on a portable power tool formed as an angle grinder, a soft start when a polishing machining tool is detected or activation of a deceleration function of a portable power tool when a cutting machining tool is detected, such as for example a cutting disk in the case of a portable power tool formed as an angle grinder. In addition to recording at least one machining tool characteristic variable by means of the machining tool sensor unit, a transmission of at least one machining tool characteristic variable by means of an RFID, a barcode, a data matrix code or the like is also conceivable. This advantageously allows there to be a clear identification of a machining tool type, for which there are stored in the memory unit of the open-loop and/or closed-loop control unit machining-tool-specific parameters, which as a result of a recording of at least one machining tool characteristic variable by the machining tool sensor unit can be adapted by means of the open-loop and/or closed-loop control unit, such as for example to a degree of wear, to a degree of imbalance etc.

Electronic data exchange between the open-loop and/or closed-loop control unit and the drive unit sensor unit and/or the machining tool sensor unit preferably takes place in a wire-bound manner. In an alternative configuration of the power tool device, an electronic data exchange between the open-loop and/or closed-loop control unit and the drive unit sensor unit and/or the machining tool sensor unit takes place in a cableless manner, such as for example by means of a Bluetooth connection, by means of a WLAN connection, by means of an NFC connection, by means of an infrared connection or the like. The open-loop and/or closed-loop control unit controls the drive unit in an open-loop and/or closed-loop manner particularly preferably at least in dependence on the drive unit characteristic variable recorded by means of the drive unit sensor unit and in dependence on the machining tool characteristic variable recorded by means of the machining tool sensor unit. Further characteristic variables that appear appropriate to a person skilled in the art and for which allowance can be made by the open-loop and/or closed-loop control unit for providing an open-loop and/or closed-loop control of the drive unit are likewise conceivable.

By means of the configuration of the power tool device according to the invention, damage to a machining tool can be advantageously detected, in particular before a workpiece is machined with the machining tool. For example, vibrations can be advantageously recorded and a corresponding warning issued to an operator if the vibrations exceed a critical value and/or an open-loop and/or closed-loop control of the drive unit can be adapted to a damaged machining tool. Consequently, a risk of an operator being injured can be advantageously kept down. Moreover, inadmissibly or incorrectly mounted machining tools can be advantageously detected. Consequently, an operator can for example be advantageously informed at an early time of a risk of breaking of a machining tool. A high level of operator safety can therefore be advantageously achieved.

It is further proposed that the power tool device comprises at least one workpiece sensor unit for recording at least one workpiece characteristic variable, which can be processed by the open-loop and/or closed-loop control unit at least for providing an open-loop and/or closed-loop control of the drive unit and/or for providing an output of information to an operator. The workpiece sensor unit is preferably intended for recording at least one material of a workpiece. Moreover, the workpiece sensor unit is additionally or alternatively intended for recording a density of a workpiece, a distance of a workpiece relative to a machining tool arranged in a tool holder, a dimension of a workpiece, a position of a workpiece and/or further workpiece characteristic variables that appear appropriate to a person skilled in the art. Consequently, an open-loop and/or closed-loop control of a drive unit that is advantageously made to match a workpiece to be machined and a machining tool arranged in a tool holder can advantageously take place. As a result, precise machining of a workpiece can be advantageously made possible. Moreover, a high rate of work progress can be advantageously made possible. As a result of a recording of at least one workpiece characteristic variable, a behavior during machining of the workpiece can be advantageously inferred. Consequently, a high level of safety with regard to the risk of splintering when machining a workpiece can be advantageously achieved.

In at least one operating mode, the open-loop and/or closed-loop control unit is advantageously intended to control the drive unit in an open-loop and/or closed-loop manner in dependence on at least one workpiece characteristic variable that is recorded by means of the workpiece sensor unit and defines an object that is located in a workpiece. For this purpose, the workpiece sensor unit preferably comprises at least one sensor element which is intended for recording at least one object located in a workpiece, such as for example a power line or water conduit, a metal object, a pipe etc. When the machining tool approaches and/or when there is direct contact between the machining tool and the workpiece to be machined, such as for example when drilling, cutting etc., it is possible that a signal tone can be emitted by means the information output unit. Moreover, it is conceivable that a power supply to the drive unit can be interrupted by the open-loop and/or closed loop control unit and/or can be used by the open-loop and/or closed-loop control unit for active deceleration of the drive unit. A risk of the machining tool being damaged during machining of a workpiece can be advantageously kept down.

Moreover, it is proposed that the drive unit sensor unit is intended for recording at least one drive unit characteristic variable formed as a ventilation characteristic variable and/or a drive unit characteristic variable formed as an operator risk characteristic variable. For this purpose, the drive unit sensor unit comprises at least one pressure sensor element, which is intended for recording an air stream and/or an air pressure in the power tool housing. If the open-loop and/or closed-loop control unit detects a drop in the air stream and/or the air pressure below a setpoint value, this at least can be output by means of the information output unit. Alternatively or in addition, it is conceivable that the drive unit sensor unit comprises at least one measuring contact element, which is intended for recording metal dust accumulations and/or metal dust bridges in and/or on the power tool housing. The recording of metal dust accumulations and/or metal dust bridges can be evaluated for example by the open-loop and/or closed-loop control unit for detecting a possibility of a discharge current from the power tool to ambient surroundings, in particular to an operator. If a discharge current from the power tool to the ambient surroundings, in particular to the operator, is detected by means of the open-loop and/or closed-loop control unit, a power supply to the power tool is interrupted. By means of the configuration of the power tool device according to the invention, a reliable admission of air to the drive unit can be advantageously ensured. This allows a long service life of the power tool to be achieved. Moreover, a high level of operator safety can be advantageously achieved.

The power tool device preferably comprises at least one input unit for an input of at least one machining characteristic variable, which can be processed by the open-loop and/or closed-loop control unit at least for providing an open-loop and/or closed-loop control of the drive unit. The input unit may be formed here as a touch-sensitive display and/or as a key-bound input interface. By means of the input unit, preferably at least a drive unit characteristic curve, a maximum rotational speed, a minimum rotational speed, a maximum torque, a minimum torque, a level of training of an operator and/or a machining location of an operator can be set by being input by an operator. It is also conceivable that alternatively or additionally machining tool characteristic variables and/or workpiece characteristic variables that can be processed by the open-loop and/or closed-loop control unit during open-loop and/or closed-loop control of the drive unit can be input by an operator by means of the input unit. Consequently, active intervention by an operator in an open-loop and/or closed-loop control of the drive unit can be advantageously achieved. Moreover, various parameters that can be used for making allowance for a safety function in an open-loop and/or closed-loop control can be advantageously input. Consequently, a power tool device that can be conveniently operated and provides a high degree of safety can be advantageously achieved.

Furthermore, a power tool, in particular a portable power tool with a power tool device according to the invention, is proposed. Particularly preferably, the power tool is formed as a portable power tool. A “portable power tool” is to be understood as meaning in particular here a power tool for machining workpieces that can be transported by an operator without a transporting machine. The portable power tool has in particular a mass that is less than 40 kg, preferably less than 10 kg and particularly preferably less than 5 kg. The portable power tool is preferably formed here as an angle grinder. In an alternative configuration, the portable power tool is formed as a hammer drill and/or a chipping hammer. In a further alternative configuration, the portable power tool is formed as a jigsaw. It is however also conceivable that the portable power tool has some other configuration that appears appropriate to a person skilled in the art, such as for example a configuration as a battery-operated power screwdriver, as an impact drill, as a grinder, as a circular saw, as a diamond drill, as a chainsaw, as a saber saw, as a planer, as a garden tool or the like. By means of the configuration of the power tool according to the invention, an advantageous adaptation to conditions of use can be made possible. Moreover, machining of a workpiece that is set individually to an operator can be advantageously made possible. Consequently, precise, power-optimized machining of a workpiece can be advantageously made possible. Moreover, a high level of safety of an operator during machining of a workpiece can be advantageously ensured.

Furthermore, a power tool system with at least one power tool according to the invention and with at least one external unit, in particular an external sensor unit, is proposed. In one configuration of the power tool system, the external unit is formed as an external noise emission sensor unit. It is possible to obtain a noise measurement, which can be used by the open-loop and/or closed-loop control unit in order for example to control a lowering of the rotational speed of the drive unit in an open-loop and/or closed-loop manner when a prescribed noise limit value is exceeded. The external unit may be formed here for example as a smartphone. Moreover, in an alternative configuration of the power tool system, the external unit is formed as an external flying spark recording unit. Consequently, a maximum distance that sparks fly can be advantageously set in dependence on a recorded instance of flying sparks, in that a rotational speed of the drive unit can be controlled by the open-loop and/or closed-loop control unit in a closed-loop manner to a maximum flying distance of the sparks in dependence on a machining tool, a material and/or an application case. For this purpose, the instance of flying sparks can for example be optically recorded and the rotational speed can be adapted for altering a distance that sparks fly. Consequently, noise-related nuisances and/or damaging effects are advantageously avoidable and/or reducible.

Furthermore, a method for controlling at least one power tool according to the invention in an open-loop and/or closed-loop manner is provided, the method comprising at least one method step, in which the open-loop and/or closed-loop control unit determines at least one operator state and outputs the operator state by means of an information output unit and/or makes allowance for it for providing an open-loop and/or closed-loop control of the drive unit and/or at least one safety function of the power tool. Moreover, the method preferably has at least one further method step, in which the open-loop and/or closed-loop control unit determines at least one power tool accessory state and outputs the power tool accessory state by means of an information output unit and/or makes allowance for it for providing an open-loop and/or closed-loop control of the drive unit and/or at least one safety function of the power tool. Consequently, an adaptation of an open-loop and/or closed-loop control of a drive unit and/or of a safety function to a state of an operator can advantageously take place. Consequently, effective protection of an operator from injuries can be advantageously made possible. By means of the method according to the invention, an at least substantially automatic setting of operating parameters and/or operating modes of a power tool can be advantageously made possible. Moreover, an at least substantially automatic activation of various safety functions of the power tool can be advantageously made possible.

Moreover, it is proposed that, in particular in at least one operating mode of the portable power tool, the open-loop and/or closed-loop control unit accesses at least partially automatically by means of the communication unit the central database, in which there is stored at least one safety and/or operating area rule, which can be processed by the open-loop and/or closed-loop control unit at least for providing an open-loop and/or closed-loop control of the drive unit. The open-loop and/or closed-loop control unit preferably evaluates the safety and/or operating area rules stored in the central database automatically and interprets the safety and/or operating area rules automatically for providing an open-loop and/or closed-loop control of the portable power tool. Particularly preferably, in addition to access to the central database by means of the communication unit, electronic data can be exchanged with at least one external unit by means of the communication unit. Consequently, a data exchange between the portable power tool comprising the power tool device and further external units can preferably take place, such as for example a data exchange between the portable power tool comprising the power tool device and a sensor unit of work clothing, a smartphone, a laptop, a PC, a handheld device, a tablet, a server or the like. In particular, the characteristic variables recorded by means of the sensor units of the power tool device and/or the data transmitted by means of the communication unit are preferably exchangeable here and/or can be used for providing an open-loop and/or closed-loop control of the portable power tool comprising the power tool device. The communication unit may have and/or use here cable-bound and/or cableless interfaces and/or communication protocols. Interfaces and/or communication protocols may be formed for example as a USB, as a Canbus, as an Ethernet, in particular with a twisted pair of cables (CAT5 or CAT6), as an optical transmission medium, as a KNX, as a Powerline, as an NFC (near field communication), as an RFID (near field communication), as a Zigbee (near field communication), as a Bluetooth, in particular to the standard 4.0 Low Energy (short range), as a WLAN, in particular to the standard 801.11n (medium range), as a GSM or an LTE (mobile radio network), in particular for long ranges, or the like. Preferably, an external unit, in particular a smartphone, is formed as a router, which is intended as a switching location at least between the communication unit of the power tool device and the central database and/or a further external unit. An individually adapted company smartphone should advantageously be used here. By means of the configuration according to the invention, allowance for safety and/or operating area rules can be advantageously made at least partially automatically for providing an open-loop and/or closed-loop control at least of the drive unit. Consequently, a high level of operating convenience and dependable compliance with safety functions can be advantageously ensured.

Furthermore, it is proposed that the open-loop and/or closed-loop control unit uses data recorded by the power tool sensor and/or data transmitted by the communication unit at least for providing an open-loop and/or closed-loop control of the drive unit. The data recorded by the power tool sensor that can be used by the open-loop and/or closed-loop control unit for providing an open-loop and/or closed-loop control of the drive unit can preferably be recorded by means of at least one of the sensor units, in particular by means of all of the sensor units, of the power tool device. Preferably, the data that are transmitted by the communication unit can be transmitted by means of the communication unit to the open-loop and/or closed-loop control unit from an external unit and/or from the central database. It is conceivable here that the data transmitted by the communication unit can be recorded for example by means of at least one sensor unit of work clothing and can be received by means of the communication unit and/or can be directly read out from the central database by means of the communication unit. The sensor units of the power tool device and/or of the external unit preferably comprise in each case at least one sensor element for recording at least one characteristic variable. The sensor element may be formed here for example as a position sensor (magnetic field sensor or the like, for recording the spatial position), as a movement sensor (speed sensor, acceleration sensor, rate of rotation sensor or the like), as a GPS sensor (X, Y, Z on the Earth's surface), as a pressure sensor (strain gage or the like), as a gas sensor (CO2 sensor; carbon monoxide sensor or the like), as a temperature sensor, as a voltage sensor, as a moisture sensor, as a pH sensor, as an air pressure sensor (barometer), as a pulse sensor or the like. By means of the configuration according to the invention, an allowance for location-dependent safety and/or operating area rules can be advantageously made and, moreover, an inclusion of data recorded by the power tool sensor and/or data transmitted by the communication unit can be used for providing an open-loop and/or closed-loop control of the portable power tool. Consequently, a high level of work safety can be advantageously ensured.

It is further proposed that the open-loop and/or closed-loop control unit outputs at least one item of information by means of an information output unit in dependence on data recorded by the power tool sensor and/or data transmitted by the communication unit. Consequently, information can be advantageously output to an operator in order for example to inform the operator about access control to an area of the infrastructure. Consequently, access control to an area of the infrastructure can be advantageously realized. It is conceivable here that for example fire prevention rules stored in the central database have the effect that an operator may only work with a specific portable power tool in defined rooms with approval or when accompanied by a member of the works fire service. Moreover, it is advantageously possible to warn persons at risk in ambient surroundings and/or in direct proximity of the place of use of the portable power tool by means of optical and/or acoustic signals.

Moreover, it is proposed that the open-loop and/or closed-loop control unit controls at least one operating mode setting of the power tool in an open-loop and/or closed-loop manner in dependence on data recorded by the power tool sensor and/or data transmitted by the communication unit. Consequently, optimum operation of the portable power tool comprising the power tool device can be advantageously achieved.

The open-loop and/or closed-loop control unit interprets, combines and/or evaluates preferably the data recorded by the power tool sensor and/or the data transmitted by the communication unit for providing an open-loop and/or closed-loop control of the portable power tool comprising the power tool device. By means of a transmission of data to the central database, it is preferably conceivable that work reports of jobs can be created at least partially automatically and that these can be recorded and/or logged by facility management staff. In this way it can be advantageously documented who worked with what type of portable power tool when, for how long and at which location. If an incident and/or an accident happens, an automatically created log can thus be advantageously used later to demonstrate observance of an obligation to take care.

As a result of establishing risk potentials, safety and/or operating area rules or the like by the health and safety engineers (HSE) and/or the facility management (FCM) for rooms, laboratories or workshops of the infrastructure, corresponding electronic data are stored in the central database. The communication of the portable power tool comprising the power tool device with the central database means that it can be identified, for example by means of locating by GPS coordinates, which portable power tool is to be found where within the infrastructure. In particular in the case of additional operator data transmission, it can in particular be recorded which operator, in particular with what level of training, is located where with which type of portable power tool. In this way it can be recorded if a portable power tool is taken into an area of the infrastructure that is unauthorized for this portable power tool and operation of the portable power tool can be disabled, information can be output to an operator and/or this can be reported to the health and safety engineers (HSE) and/or the facility management (FCM). Consequently, access monitoring can advantageously take place. It can be advantageously monitored and/or checked in which areas of the infrastructure a portable power tool may be used and whether an operator has to present evidence of permission for use. Consequently, a monitoring of rules can advantageously take place with regard to unaccompanied work and/or automatic one-man monitoring can take place by at least one sensor element of the work clothing in combination with sensor units of the power tool device.

It is also conceivable that electronic data which define limit values for ambient conditions, such as for example temperature limit values, air and/or gas concentration values, are stored in the central database by for example a health and safety engineer (HSE) and/or the facility management (FCM). As a result of a transmission of the electronic data from the central database and a transmission of data recorded by the power tool sensor to the central database, monitoring and/or demonstration of compliance with limit values is advantageously possible.

It is conceivable furthermore that an adjustment of a permission for use takes place by means of the electronic data transmitted by the communication unit. Here it is conceivable for example for training and/or instruction of the operator to be demonstrated by an input (chip card, RFID chip or the like) or by an adjustment of an operator identification profile stored in the central database, in order to make it possible for the portable power tool to be put into operation. If it has been put into operation without authorization having been properly demonstrated, the portable power tool can for example be disabled or for example a warning can be issued by means of the information output unit or a central control station can be informed.

Moreover, it is also conceivable that data of the portable power tool, such as for example the running time, vibrations, rechargeable battery capacity, cooling unit power, motor power or the like, can be transmitted by means of the communication unit to an operator-side unit, such as for example a user interface, a wristwatch, a smartphone, data goggles or the like. The data of the portable power tool can also be transmitted to the central database in order for example to be able to monitor compliance with limit values. Moreover, for example, employees of an outside company who are within the infrastructure can be monitored. Consequently, for example, a working time and/or a working location of the employees of the outside company can be logged. Furthermore, it is possible by means of a transmission of electronic data by means of the communication unit preferably for an operator profile to be set up by the open-loop and/or closed-loop control unit. When there is a transmission of data by means of the communication unit, settings of the portable power tool can preferably be performed here automatically by the open-loop and/or closed-loop control unit, such as for example authorization settings, the setting of a preferred motor characteristic curve, the setting of a response behavior of safety functions (kickback function etc.) or the like.

Furthermore, in particular as a result of an adjustment of electronic data from the central database, of data recorded by the power tool sensor and of data recorded by means of at least one sensor unit of an operator's work clothing, automatic monitoring of an obligation to wear personal protective equipment (PPE), which for example comprises a helmet, at least one glove, at least one pair of protective goggles, safety shoes, work pants or the like, and/or monitoring of a restriction of the locations where a portable power tool can be used can be achieved. Here it is conceivable that an emergency switch-off of the portable power tool can be instigated by a central control station in an area of the infrastructure as soon as at least one vital characteristic variable of an operator reaches a value that is critical for an operator.

Moreover, a central update function for the portable power tool can be advantageously made possible by means of a transmission of electronic data from a central database. Furthermore, when maintenance is due, such as for example a change of carbon brushes, can be advantageously transmitted to a central control station.

The power tool device according to the invention, the power tool according to the invention and/or the method according to the invention is/are not to be restricted here to the application and embodiment described above.

In particular, the power tool device according to the invention, the power tool according to the invention and/or the method according to the invention may have a number of individual elements, components, units and/or method steps other than the number mentioned herein for achieving a manner of functioning described herein.

### DRAWING

Further advantages emerge from the following description of the drawing. In the drawing, exemplary embodiments of the invention are represented. The drawing, the description and the claims contain numerous features in combination. A person skilled in the art will expediently also consider the features individually and bring them together into further appropriate combinations.

In the drawing:

FIG. 1 shows a power tool according to the invention, which is formed as an angle grinder, with at least one power tool device according to the invention in a schematic representation,

FIG. 2 shows a schematic representation of the power tool device according to the invention,

FIG. 3 shows a schematic representation of an alternative power tool device according to the invention,

FIG. 4 shows an alternative power tool according to the invention, which is formed as a hammer drill and/or a chipping hammer, with a power tool device according to the invention in a schematic representation,

FIG. 5 shows a further alternative power tool according to the invention, which is formed as a battery-operated screwdriver, with a power tool device according to the invention in a schematic representation and

FIG. 6 shows a further alternative power tool according to the invention, which is formed as a jigsaw, with a power tool device according to the invention in a schematic representation.

### DESCRIPTION OF THE EXEMPLARY EMBODIMENTS

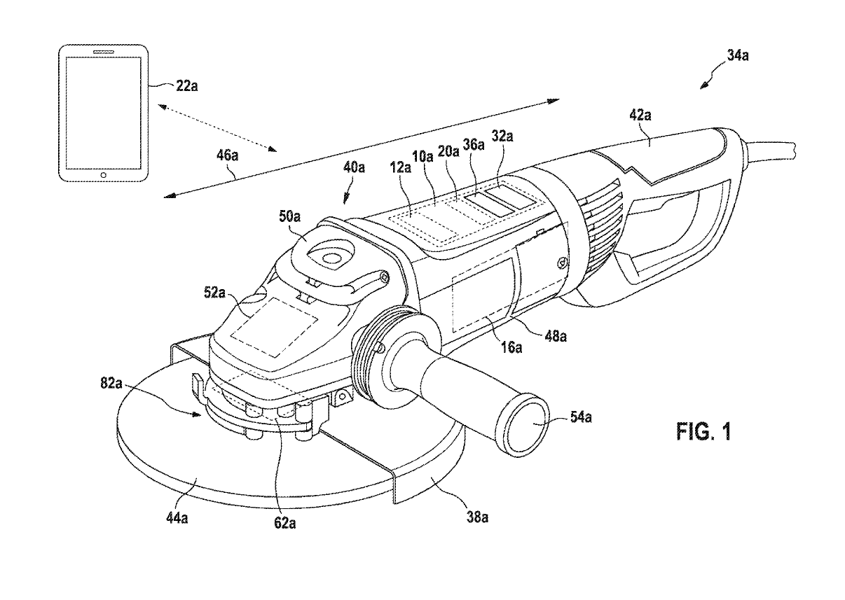

FIG. 1 shows a power tool 34a with at least one power tool device 10a. The power tool 34a is formed as a portable power tool. Here, the power tool 34a is formed as an angle grinder. Consequently, the power tool 34a comprises at least one power tool accessory unit 38a, formed as a protective shroud unit. The power tool 34a also comprises at least one power tool housing 40a and a main handle 42a, which extends on a side of the power tool housing 40a that is facing away from a machining tool 44a in the direction of a main direction of extent 46a of the power tool 34a. The machining tool 44a is formed here as a grinding disk. It is however also conceivable that the machining tool 44a is formed as a cutting or polishing disk. The power tool housing 40a comprises a motor housing 48a for receiving a drive unit 16a of the power tool 34a. The power tool housing 40a further comprises a transmission housing 50a for receiving an output unit 52a of the power tool 34a. The drive unit 16a is intended for driving the machining tool 44a in a rotational manner by way of the output unit 52a. Arranged on the transmission housing 50a is a further power tool accessory unit 54a, formed as an additional handle unit. The power tool accessory unit 54a formed as an additional handle unit extends transversely in relation to the main direction of extent 46a of the power tool 34a.

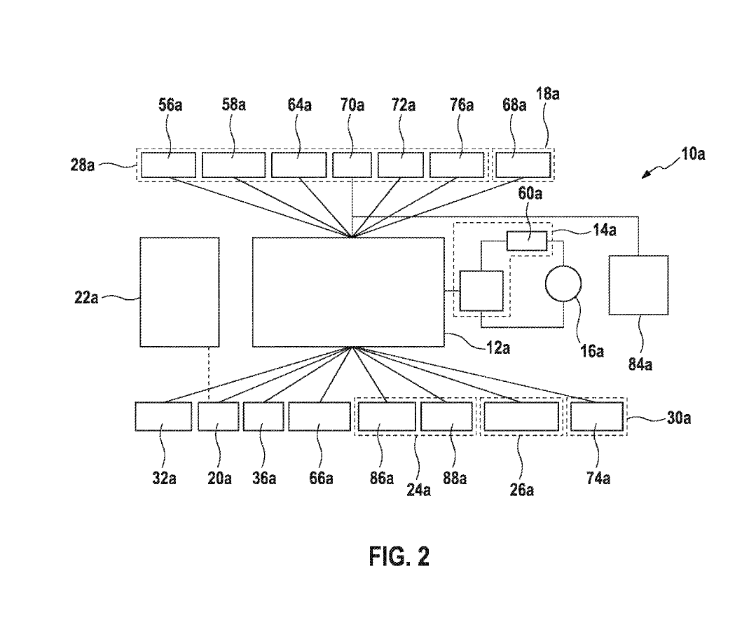

The power tool device 10a is formed as a handheld power tool device. The power tool device 10a preferably comprises a power supply device 84a (FIG. 2). Consequently, the power tool device 10a can be operated independently of a power supply of the power tool 34a. It is however also conceivable that, in an alternative configuration of the power tool device 10a, the power tool device 10a can be supplied with power by means of a power supply device of the power tool 34a. The power tool device 10a further comprises at least one open-loop and/or closed-loop control unit 12a and at least one drive unit sensor unit 14a for recording at least one drive unit characteristic variable, which can be processed by the open-loop and/or closed-loop control unit 12a for at least providing an open-loop and/or closed-loop control of a drive unit 16a of the power tool 34a and/or for providing an output of information to an operator. In at least one operating mode of the power tool 34a, the open-loop and/or closed-loop control unit 12a is intended for providing an open-loop and/or closed-loop control of the drive unit 16a in dependence on the at least one drive unit characteristic variable recorded by means of the drive unit sensor unit 14a. The drive unit sensor unit 14a is further intended for recording at least one drive unit characteristic variable formed as a ventilation characteristic variable and/or a drive unit characteristic variable formed as an operator risk characteristic variable.

Furthermore, the power tool device 10a comprises at least one operator sensor unit 18a for recording at least one operator-specific characteristic variable, which can be processed by the open-loop and/or closed-loop control unit 12a at least for providing an open-loop and/or closed-loop control of the drive unit 16a and/or for providing an output of information to an operator. The open-loop and/or closed-loop control unit 12a is intended for providing an open-loop and/or closed-loop control of the drive unit 16a in dependence on the at least one operator-specific characteristic variable recorded by means of the operator sensor unit 18a and in dependence on the at least one drive unit characteristic variable recorded by means of the drive unit sensor unit 14a.

The power tool device 10a further comprises at least one power tool accessory sensor unit 26a for recording at least one power tool accessory characteristic variable, which can be processed by the open-loop and/or closed-loop control unit 12a at least for providing an open-loop and/or closed-loop control of the drive unit 16a and/or for providing an output of information to an operator. In at least one operating mode of the power tool 34a, the open-loop and/or closed-loop control unit 12a is intended for providing an open-loop and/or closed-loop control of the drive unit 16a in dependence on the at least one drive unit characteristic variable recorded by means of the drive unit sensor unit 14a, in dependence on the at least one operator-specific characteristic variable recorded by means of the operator sensor unit 18a and in dependence on the at least one power tool accessory characteristic variable recorded by means of the power tool accessory sensor unit 26a. The power tool device 10a further comprises at least one machining tool sensor unit 28a for recording at least one machining tool characteristic variable, which can be processed by the open-loop and/or closed-loop control unit 12a at least for providing an open-loop and/or closed-loop control of the drive unit 16a and/or for providing an output of information to an operator. At least in an initial learning operating mode, the open-loop and/or closed-loop control unit 12a is intended here for providing an at least partially automatic open-loop and/or closed-loop control of the drive unit 16a in dependence on the at least one drive unit characteristic variable recorded by means of the drive unit sensor unit 14a, in dependence on the at least one machining tool characteristic variable recorded by means of the machining tool sensor unit 28a, in dependence on the at least one operator-specific characteristic variable recorded by means of the operator sensor unit 18a and in dependence on the at least one power tool accessory characteristic variable recorded by means of the power tool accessory sensor unit 26a. The initial learning operating mode is automatically activated after the power tool 34a is put into operation, until an idling speed is reached. A centrifugal mass of the machining tool 44a can be determined by means of the open-loop and/or closed-loop control unit 12a by way of at least one inertia sensor 56a of the machining tool sensor unit 28a, at least one torque sensor 58a of the machining tool sensor unit 28a and/or a current sensor 60a of the drive unit sensor unit 14a (FIG. 2). The inertia sensor 56a is preferably formed as a three-axis acceleration sensor. The determined centrifugal mass can be unequivocally assigned to a certain machining tool type by way of at least one characteristic map stored in a memory unit (not represented any more specifically here) of the open-loop and/or closed-loop control unit 12a. It is also conceivable that a recording of further machining tool characteristic variables additionally takes place by way of RFID, NFC, scanning a barcode, data matrix codes or the like. Drive unit parameters can be adapted and/or can be changed in dependence on the machining tool 44a determined by the open-loop and/or closed-loop control unit 12a for providing an open-loop and/or closed-loop control of the drive unit 16a.

In the initial learning operating mode of the power tool 34a, a rotational speed that is optimum for the machining tool 44a can be set at least partially automatically by means of the open-loop and/or closed-loop control unit 12a in dependence on a material (steel, stainless steel, stone, concrete, wood etc.) of a workpiece to be machined. For this purpose, the power tool device 10a has at least one workpiece sensor unit 30a for recording at least one workpiece characteristic variable, which can be processed by the open-loop and/or closed-loop control unit 12a at least for providing an open-loop and/or closed-loop control of the drive unit 16a and/or for providing an output of information to an operator. For this purpose, the workpiece sensor unit 30a comprises at least one workpiece sensor element 74a (FIG. 2). At least in the initial learning operating mode, the open-loop and/or closed-loop control unit 12a is intended here for providing an at least partially automatic open-loop and/or closed-loop control of the drive unit 16a in dependence on the at least one drive unit characteristic variable recorded by means of the drive unit sensor unit 14a, in dependence on the at least one operator-specific characteristic variable recorded by means of the operator sensor unit 18a, in dependence on the at least one machining tool characteristic variable recorded by means of the machining tool sensor unit 28a, in dependence on the at least one power tool accessory characteristic variable recorded by means of the power tool accessory sensor unit 26a and in dependence on the at least one workpiece characteristic variable recorded by means of the workpiece sensor unit 30a.

Furthermore, in the initial learning operating mode of the power tool 34a, abnormalities with regard to vibration of the machining tool 44a during running up to an idling speed of the drive unit 16a can be recorded. As a result, incorrect mounting, wear and/or a defect of the machining tool 44a can be recorded. Consequently, by means of the open-loop and/or closed-loop control unit 12a, information can be output to an operator by way of an information output unit 36a of the power tool device 10a and/or the drive unit 16a can be actively decelerated and/or a power supply to the drive unit 16a can be interrupted. Moreover, as a result of a determination of the machining tool 44a, a rotational speed of the drive unit 16a that is suitable as a maximum for the machining tool 44a can be set. Consequently, at least in the initial learning operating mode, the open-loop and/or closed-loop control unit 12a determines a machining tool state and outputs the machining tool state by means of the information output unit 36a and/or makes allowance for the machining tool state for providing an open-loop and/or closed-loop control of the drive unit 16a of the power tool 34a.

Moreover, the power tool 34a has at least one machining tool securing unit 62a, which comprises at least one securing element (not represented any more specifically here) for securing the machining tool 44a to a tool holder 82a of the power tool 34a. Here, the machining tool sensor unit 28a has at least one securing sensor element 64a, which is intended for monitoring secure fastening of the machining tool 44a to the tool holder 82a. If the securing sensor element 64a records a detached state of the machining tool 44a, a power supply to the drive unit 16a can be interrupted by means of the open-loop and/or closed-loop control unit 12a. Consequently, operation of the drive unit 16a is disabled. It is conceivable that a drive spindle and/or a clamping nut of the power tool 34a has a bore into which the securing element is insertable, in particular is insertable by way of a servomotor, the position of which can be recorded by means of the securing sensor element 64a. Furthermore, it is also conceivable that a securing element formed as a clamping nut can be prestressed by means of an at least partially automatic tightening unit to a defined torque, it being possible for the torque to be recorded by means of the torque sensor 58a.

Furthermore, in one configuration of the power tool device 10a a vibration exciter element 66a (FIG. 2) of the power tool device 10a, by means of which a secure arrangement of the machining tool 44a on the drive spindle can be checked, is arranged in the securing element formed as a clamping nut. The vibration exciter element 66a may be formed as a smart material element, as a piezo element, as an oscillating coil element or as some other exciter element that appears appropriate to a person skilled in the art. Here, the vibration exciter element 66a can be used to set the machining tool 44a in vibration, which can be recorded by means of the machining tool sensor unit 28a and can be evaluated by means of the open-loop and/or closed-loop control unit 12a. The machining tool 44a can furthermore be divided into portions by means of the open-loop and/or closed-loop control unit 12a, it being possible for each portion to be evaluated individually by the open-loop and/or closed-loop control unit 12a with regard to a vibration. Consequently, damage to the machining tool 44a in one portion can be advantageously detected. Further configurations that appear appropriate to a person skilled in the art for recording machining tool characteristic variables are likewise conceivable.

The power tool device 10a further comprises at least one ambient sensor unit 24a for recording at least one ambient characteristic variable, which can be processed by the open-loop and/or closed-loop control unit 12a at least for providing an open-loop and/or closed-loop control of the drive unit 16a and/or for providing an output of information to an operator. The ambient sensor unit 24a comprises at least one position sensor 86a, which records a spatial alignment of the power tool 34a. The position sensor 86a is preferably formed as a three-axis movement sensor. It is however also conceivable that the position sensor 86a has some other configuration that appears appropriate to a person skilled in the art. Moreover, the ambient sensor unit 24a has at least one location determination sensor 88a, which records a global position of the power tool 34a. The location determination sensor 88a is preferably formed as a GPS sensor. It is however also conceivable that the location determination sensor 88a has some other configuration that appears appropriate to a person skilled in the art.

The power tool device 10a further comprises at least one input unit 32a for providing an input of at least one machining characteristic variable, which can be processed by the open-loop and/or closed-loop control unit 12a at least for providing an open-loop and/or closed-loop control of the drive unit 16a. By means of the input unit 32a, at least an open-loop and/or closed-loop control of the drive unit 16a can be influenced by the open-loop and/or closed-loop control unit 12a. Moreover, by means of the input unit 32a, an operating mode of the power tool 34a can be set. The power tool 34a has here at least the initial learning operating mode, a learning operating mode, a reference operating mode, a safety operating mode, a synchronization operating mode and/or an automatic operating mode. At least in the safety operating mode, the open-loop and/or closed-loop control unit 12a is intended here for providing an at least partially automatic open-loop and/or closed-loop control of the drive unit 16a in dependence on the at least one drive unit characteristic variable recorded by means of the drive unit sensor unit 14a, in dependence on the at least one operator-specific characteristic variable recorded by means of the operator sensor unit 18a, in dependence on the at least one machining tool characteristic variable recorded by means of the machining tool sensor unit 28a, in dependence on the at least one power tool accessory characteristic variable recorded by means of the power tool accessory sensor unit 26a, in dependence on the at least one ambient characteristic variable recorded by means of the ambient sensor unit 24a, in dependence on the electronic data received at least by means of a communication unit 20a of the power tool device 10a and in dependence on the at least one workpiece characteristic variable recorded by means of the workpiece sensor unit 30a.

By means of the position sensor 86a of the ambient sensor unit 24a, a spatial alignment of the power tool 34a can be recorded. Consequently, for example, overhead work with the power tool 34a, which entails a higher risk of an operator being injured than work with the power tool 34a in which the operator handles the power tool 34a below his head, can be detected by means of the open-loop and/or closed-loop control unit 12a. When overhead work is detected, the safety operating mode can be activated automatically by the open-loop and/or closed-loop control unit 12a if it has until then been unactivated. In the safety operating mode, safety functions are activated more quickly than in other operating modes of the power tool 34a.

Furthermore, a global position of the power tool 34a can be recorded by means of the location determination sensor 88a of the ambient sensor unit 24a. Consequently, in dependence on a location characteristic variable transmitted by means of the communication unit 20a and in dependence on a global position of the power tool recorded by means of the location determination sensor 88a, it can be evaluated by means of the open-loop and/or closed-loop control unit 12a whether the power tool 34a is in an area where safety is at risk and restricted machining of workpieces is allowed here. When a global position is detected in an area where safety is at risk, a necessity for automatic activation of the safety operating mode can be evaluated by the open-loop and/or closed-loop control unit 12a if it has until then been unactivated. Here, the open-loop and/or closed-loop control unit 12a adapts at least one parameter stored in a memory unit of the open-loop and/or closed-loop control unit 12a for providing an open-loop and/or closed-loop control of the drive unit 16a at least in dependence on at least the ambient characteristic variable recorded by means of the ambient sensor unit 24a and formed as a global position.

Moreover, in dependence on an operator state being recorded by means of the operator sensor unit 18a and/or an operator state, such as for example a level of training of an operator, being transmitted from an external unit 22a by means of the communication unit 20a to the open-loop and/or closed-loop control unit 12a, the safety operating mode can be activated automatically by the open-loop and/or closed-loop control unit 12a if it has until then been unactivated.

Moreover, a position of both hands of an operator can be recorded by means of the operator sensor unit 18a. In the safety operating mode, a power supply to the drive unit 16a can be interrupted in the event of one-handed operation by the operator if two-handed operation of the power tool 34a is prescribed. Moreover, it is conceivable that an engaging function for a snap-in engagement of an operating element of the power tool 34a is deactivated in the safety operating mode and only a dead man's function is activated. Consequently, safe guidance of the power tool 34a can be advantageously achieved.

The operator sensor unit 18a also comprises at least one operator sensor element 68a (FIG. 2), which is intended for recording at least one operator-specific characteristic variable. The operator sensor element 68a is formed here as a vibration sensor, in particular as a three-axis acceleration sensor. By means of the operator sensor unit 18a, in particular a vibration that acts on an operator can be recorded on the power tool housing 40a and/or on the main handle 42a. By means of the open-loop and/or closed-loop control unit 12a, a rotational speed can be altered when a resonance and/or a maximum vibration value is reached. Moreover, a pressing pressure and/or a pressing force of an operator on the power tool 34a can be recorded by means of the operator sensor unit 18a. Consequently, safe guidance of the power tool 34a can be advantageously monitored. Moreover, in the safety operating mode, a protective shroud unit position of the protective shroud unit can be actively changed by means of the open-loop and/or closed-loop control unit 12a, in particular as a result of recording a position of the protective shroud unit by the power tool accessory sensor unit 26a. In the safety operating mode, the open-loop and/or closed-loop control unit 12a consequently determines at least one operator state and outputs the operator state by means of the information output unit 36a and/or makes allowance for the operator state for providing an open-loop and/or closed-loop control of the drive unit 16a and/or at least one safety function of the power tool 34a.

Moreover, an operator-specific characteristic variable of an operator that is formed as a pulse and/or as a body temperature and can be used for assessing for example a stage of fatigue of the operator by the open-loop and/or closed-loop control unit 12a can be recorded by means of the operator sensor unit 18a. Furthermore, electronic data with regard to safety clothing and/or equipment of an operator can be transmitted by means of the communication unit 20a to the open-loop and/or closed-loop control unit 12a. Consequently, a necessity for activation of the safety operating mode can be evaluated by means of the open-loop and/or closed-loop control unit 12a in dependence on the operator-specific characteristic variable and in dependence on the electronic data. Moreover, characteristic variables of the ambient sensor unit 24a, of the power tool accessory sensor unit 26a, of the machining tool sensor unit 28a and/or of the workpiece sensor unit 30a can likewise be included for this purpose. Furthermore, the open-loop and/or closed-loop control unit 12a is intended for detecting at least in dependence on the at least one operator-specific characteristic variable operation of the power tool 34a that cannot be controlled by an operator. Moreover, the open-loop and/or closed-loop control unit 12a is intended for outputting at least one emergency signal by means of the communication unit 20a at least in dependence on at least one operator-specific characteristic variable recorded by means of the operator sensor unit 18a, in particular when it is detected that an operator is at risk and/or is injured. Furthermore, the open-loop and/or closed-loop control unit 12a is intended for controlling the drive unit 16a in an open-loop and/or closed-loop manner and/or for outputting an item of information by means of the information output unit to an operator at least in dependence on an operator-specific characteristic variable formed as operator exposure to stress, in particular on an operator-specific characteristic variable formed as an operator vibration exposure level.

Furthermore, the open-loop and/or closed-loop control unit 12a is intended for accessing by means of the communication unit 20a a central database, in which there is stored at least one safety and/or operating area rule, which can be processed by the open-loop and/or closed-loop control unit 12a at least for providing an open-loop and/or closed-loop control of the drive unit 16a. Here, in at least one operating mode, the open-loop and/or closed-loop control unit 12a accesses at least partially automatically by means of the communication unit 20a the central database, in which there is stored at least one safety and/or operating area rule that can be processed by the open-loop and/or closed-loop control unit 12a at least for providing an open-loop and/or closed-loop control of the drive unit 16a. Consequently, the open-loop and/or closed-loop control unit 12a uses data recorded by the power tool sensor and/or data transmitted by the communication unit at least for providing an open-loop and/or closed-loop control of the drive unit 16a. Furthermore, the open-loop and/or closed-loop control unit 12a outputs at least one item of information by means of an information output unit 36a of the power tool device 10a in dependence on data recorded by the power tool sensor and/or data transmitted by the communication unit, in particular for informing an operator about a state of the power tool and/or for warning that there is a risk. Moreover, the open-loop and/or closed-loop control unit 12a controls at least one operating mode setting of the power tool in an open-loop and/or closed-loop manner in dependence on data transmitted by the communication unit.

In the learning operating mode, the open-loop and/or closed-loop control unit 12a is intended for providing an at least partially automatic open-loop and/or closed-loop control of the drive unit 16a in dependence on the at least one drive unit characteristic variable recorded by means of the drive unit sensor unit 14a, in dependence on the at least one machining tool characteristic variable recorded by means of the machining tool sensor unit 28a and in dependence on the at least one power tool accessory characteristic variable recorded by means of the power tool accessory sensor unit 26a. The learning operating mode is carried out here after activation by means of the input unit 32a up until switching over to another operating mode of the power tool 34a or up until switching off of the power tool 34. As long as the learning operating mode is activated, all of the aforementioned characteristic variables are constantly monitored by means of the respective sensor units and parameters and/or characteristic curves of the drive unit 16a are adapted by means of the open-loop and/or closed-loop control unit 12a.

In the synchronization operating mode of the power tool 34a, a connection to the external unit 22a can be established at least substantially automatically. For this purpose, the power tool device 10a comprises at least the communication unit 20a for communication with at least the external unit 22a for an exchange of electronic data at least for providing an open-loop and/or closed-loop control of the drive unit 16a. Maps of characteristic curves can be transmitted here by means of the communication unit 20a for providing an open-loop and/or closed-loop control of the drive unit 16a. Stored here in the external unit 22a are parameters and/or characteristic curves for providing an open-loop and/or closed-loop control of the drive unit 16a, which can be transmitted to the open-loop and/or closed-loop control unit 12a as a result of a connection between the external unit 22a and the communication unit 20a. The parameters and/or characteristic curves may be individual settings of an operator, such as for example a rapid run-up to a desired rotational speed of the drive unit 16a, stipulations by a company, such as for example that machining of workpieces can only be carried out in a dangerous area if safety accessory requirements are met, or the like.

Adjustment of a job assignment for an operator can be achieved here in the synchronization operating mode with a machining job assignment stored in the external unit 22a. Adjustment of the type of tool, type of machining, type of workpiece, etc. mentioned in the job assignment takes place. Moreover, in the synchronization operating mode, an access authorization can be issued and/or, in dependence on an access authorization, the action of putting the power tool 34a into operation can be disabled and/or enabled. In the synchronization operating mode there is moreover a transmission of working location characteristic variables, which can be evaluated by the open-loop and/or closed-loop control unit 12a with regard to activation of the safety operating mode.

Moreover, in the synchronization operating mode, vibration values, which can be recorded by means of the operator sensor unit 18a and can be used for the payment of bonuses or for monitoring an amount of vibration to which an operator is exposed per day, can be transmitted to the external unit 22a. Furthermore, a running time and a type of loading of the power tool 34a can be recorded and can be transmitted to the external unit 22a. As a result, a proposal for a different machining tool and/or a different power tool or the like can be output by means of the information output unit 36a.

In the automatic operating mode of the power tool 34a, the aforementioned operating modes are selected automatically by the open-loop and/or closed-loop control unit 12a, in particular in dependence on recorded characteristic variables that can be determined by means of the aforementioned sensor units. In the automatic operating mode there is an at least substantially automatic open-loop and/or closed-loop control of the drive unit 16a by the open-loop and/or closed-loop control unit 12a in dependence on the machining tool sensor unit 28a, on the operator sensor unit 18a, on the workpiece sensor unit 30a, on the power tool accessory sensor unit 26a and on the ambient sensor unit 24a. The open-loop and/or closed-loop control unit 12a is intended here in at least one operating mode to control the drive unit 16a in an open-loop and/or closed-loop manner in dependence on at least one workpiece characteristic variable that is recorded by means of the workpiece sensor unit 30a and defines an object located in a workpiece.

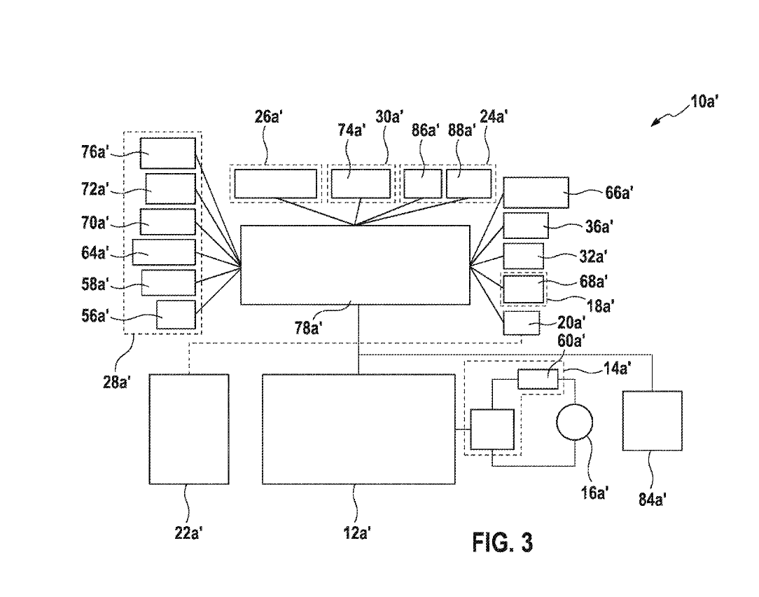

In FIG. 3, an alternative power tool device 10a′ is represented. The alternative power tool device 10a′ has an at least substantially analogous configuration in comparison with the power tool device 10a schematically represented in FIG. 2. As a difference from the power tool device 10a schematically represented in FIG. 2, the alternative power tool device 10a′ schematically represented in FIG. 3 has at least one preprocessing unit 78a′. The preprocessing unit 78a′ is intended to organize a communication of a number of sensor elements and/or sensor units of the alternative power tool device 10a′ with one another and/or with an open-loop and/or closed-loop control unit 12a′ of the alternative power tool device 10a′. The preprocessing unit 78a′ is intended here to combine individual sensor signals and make preliminary decisions. A communication between the preprocessing unit 78a′ and the open-loop and/or closed-loop control unit 12a′ may take place here in a cableless and/or cable-bound manner.

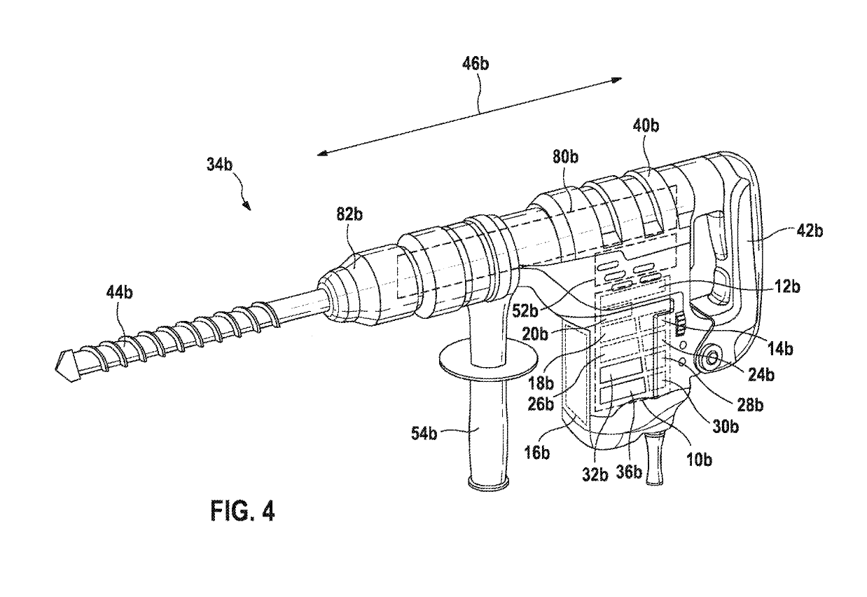

FIGS. 4 to 6 show further exemplary embodiments of the invention. The following description and the drawing are substantially confined to the differences between the exemplary embodiments, it being possible in principle also to refer to the drawing and/or the description of the other exemplary embodiments, in particular of FIGS. 1 to 3, with respect to components with the same designations, in particular with respect to components with the same reference numerals. To distinguish between the exemplary embodiments, the letter a has been added after the reference numerals of the exemplary embodiment in FIGS. 1 to 3. In the exemplary embodiments of FIGS. 4 to 6, the letter a has been substituted by the letters b or c.

FIG. 4 shows a power tool 34b with at least one power tool device 10b. The power tool 34b is formed as a portable power tool. The power tool 34b is formed here as a hammer drill and/or a chipping hammer. The power tool 34b comprises at least one percussion mechanism device 80b. The power tool 34b further comprises a power tool housing 40b, arranged on which, in a front region, is a tool holder 82b of the power tool 34b for receiving a machining tool 44b. On a side facing away from the front region, the power tool 34b comprises a main handle 42b for guiding the power tool 34b and for transmission of a force, in particular a pressing force, from an operator to the power tool 34b. The power tool 34b is further formed with a detachable additional handle unit. The additional handle unit may be detachably fastened here to the power tool housing 40b by way of a snap-in connection or other connections that appear appropriate to a person skilled in the art.

For generating a drive moment and for generating a percussive impulse by means of the percussion mechanism device 80b, the power tool 34b has a drive unit 16b. By way of an output unit 52b of the power tool 34b, a drive moment of the drive unit 16b for generating a percussive impulse is transmitted to the percussion mechanism device 80b. It is however also conceivable that the power tool 34b is formed in such a way that it is decoupled from the output unit 52b and the drive unit 16b acts substantially directly on the percussive mechanism device 80b for generating a percussive impulse. A percussive impulse of the percussion mechanism device 80b is generated in a way that is known to a person skilled in the art. A rotating drive of the tool holder 82b, and consequently of the machining tool 44b, is likewise generated in a way that is already known to a person skilled in the art.

By analogy with the power tool device 10a described in the description of FIGS. 1 to 3, the power tool device 10b comprises at least one machining tool sensor unit 28b, at least one operator sensor unit 18b, at least one workpiece sensor unit 30b, at least one power tool accessory sensor unit 26b, at least one ambient sensor unit 24b, at least one input unit 32b, at least one communication unit 20b and at least one information output unit 36b.

By means of the input unit 32b, an operating mode of the power tool 34b can be set. The power tool 34b has here at least an initial learning operating mode, a learning operating mode, a reference operating mode, a synchronization operating mode, a safety operating mode and/or an automatic operating mode. In the initial learning operating mode, a machining tool characteristic variable can be recorded by means of the machining tool sensor unit 28b. A machining tool diameter of the machining tool 44b arranged in the tool holder 82b can be determined by way of a machining tool sensor element 70b formed as a displacement sensor and/or a distance sensor. The machining tool sensor unit 28a may comprise here further machining tool sensor elements 72a, 76a that appear appropriate to a person skilled in the art.

By means of the operator sensor element 68b of the operator sensor unit 18b, a time of operator machining and/or an operator exposure to vibration can be recorded. Consequently, a necessity for activation of the safety operating mode can be evaluated by means of the open-loop and/or closed-loop control unit 12b in dependence on the time of operator machining and/or operator exposure to vibration. Moreover, characteristic variables of the ambient sensor unit 24b, of the power tool accessory sensor unit 26b, of the machining tool sensor unit 28b and/or of the workpiece sensor unit 30b can likewise be included for this purpose. For example, a torque clutch of the power tool 34b can be set here to a low slip moment by means of the open-loop and/or closed-loop control unit 12b. As a result, when there is jamming of the machining tool 44b, a small torque can be transferred to an operator and a risk of injury can be advantageously kept low.

Moreover, a spatial position of the power tool 34b can be recorded by means of a position sensor 86b of the ambient sensor unit 24b. At least one position compensating element (not represented any more specifically here), such as for example a gyroscope element, which acts in an assisting manner in maintaining a drilling angle, can be activated by means of the open-loop and/or closed-loop control unit 12b. Consequently, maintaining a drilling angle previously set by means of the input unit 32b is advantageously achievable.

In the reference operating mode, moreover, an optimum operating point can be determined by the open-loop and/or closed-loop control unit 12b by means of an evaluation of characteristic variables of the machining tool sensor unit 28b, of the operator sensor unit 18b, of the workpiece sensor unit 30b, of the power tool accessory sensor unit 26b, of the ambient sensor unit 24b, of the input unit 32b, of the communication unit 20b and/or of the information output unit 36b. For example, a torque, a rotational speed and/or a pressing pressure, which can be evaluated by the open-loop and/or closed-loop control unit 12b, can be recorded for this purpose. With regard to further features of the power tool device 10b, reference may be made to the power tool device 10a described in the description of FIGS. 1 to 3.

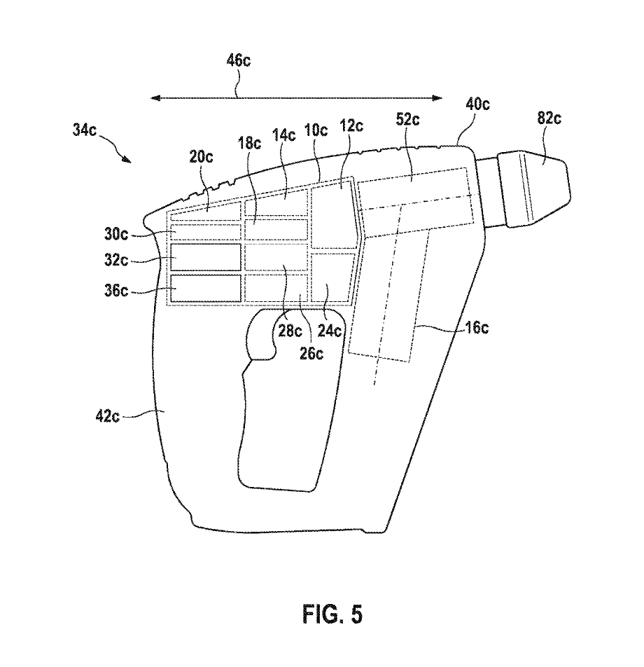

FIG. 5 shows a power tool 34c with at least one power tool device 10c. The power tool 34c is formed as a portable power tool. The power tool 34c is formed here as a battery-operated screwdriver. The power tool 34c comprises at least one power tool housing 40c, arranged on which, in a front region, is a tool holder 82c of the power tool 34c for receiving a machining tool (not represented any more specifically here). On a side facing away from the front region, the power tool 34c comprises a main handle 42c for guiding the power tool 34c and for transmission of a force, in particular a pressing force, from an operator to the power tool 34c. The power tool 34c has a drive unit 16c for generating a drive moment. A drive moment of the drive unit 16c for generating a rotational movement is transmitted to the tool holder 82c by way of an output unit 52c of the power tool 34c. It is however also conceivable that the power tool 34c is formed in such a way that it is decoupled from the output unit 52c and the drive unit 16c acts substantially directly on the tool holder 82c for generating a rotational movement. A rotating drive of the tool holder 82c and of the machining tool is consequently produced in a way that is already known to a person skilled in the art.

By analogy with the power tool device 10a described in the description of FIGS. 1 to 3, the power tool device 10c comprises at least one machining tool sensor unit 28c, at least one operator sensor unit 18c, at least one workpiece sensor unit 30c, at least one power tool accessory sensor unit 26c, at least one ambient sensor unit 24c, at least one input unit 32c, at least one communication unit 20c and at least one information output unit 36c.

By means of the input unit 32c, an operating mode of the power tool 34c can be set. The power tool 34c has here at least an initial learning operating mode, a learning operating mode, a reference operating mode, a synchronization operating mode, a safety operating mode and/or an automatic operating mode. In the initial learning operating mode, a machining tool characteristic variable can be recorded by means of the machining tool sensor unit 28c. A machining tool diameter of the machining tool arranged in the tool holder 82c can be determined by way of a machining tool sensor element 70c formed as a displacement sensor and/or a distance sensor.

In the synchronization operating mode, a connection between the open-loop and/or closed-loop control unit 12c and a charger (not represented any more specifically here) can be established. It can be evaluated by means of the open-loop and/or closed-loop control unit 12c when a rechargeable battery arranged on the power tool 34c is discharged and when a rechargeable battery arranged in the charger is fully charged. It can consequently be extrapolated when the rechargeable battery that is in use is discharged and, according to requirements, the second rechargeable battery must be charged sparingly or rapidly.

A safe standing position of an operator can be recorded and/or can be evaluated by means of an operator sensor element 68c of the operator sensor unit 18c and/or by means of a transmission of an operator standing characteristic variable from the communication unit 20c, which communicates with an external unit (not represented any more specifically here) formed as a safety clothing monitoring unit, to the open-loop and/or closed-loop control unit 12c. The safe standing position can be recorded for example as a result of a sensor element in a working shoe of an operator and be transmitted to the open-loop and/or closed-loop control unit 12c by means of the communication unit 20c. Furthermore, an operator fatigue characteristic variable can be recorded by means of the operator sensor unit 18c in dependence on a reaction time of an intervention by an operator for example in response to a sudden countertorque and/or a value of a gripping force of an operator. Consequently, a necessity for activation of the safety operating mode can be evaluated by means of the open-loop and/or closed-loop control unit 12c in dependence on the operator standing characteristic variable and/or an operator fatigue characteristic variable. Moreover, characteristic variables of the ambient sensor unit 24c, of the power tool accessory sensor unit 26c, of the machining tool sensor unit 28c and/or of the workpiece sensor unit 30c can likewise be included for this purpose. With regard to further features of the power tool device 10c, reference may be made to the power tool device 10a described in the description of FIGS. 1 to 3.

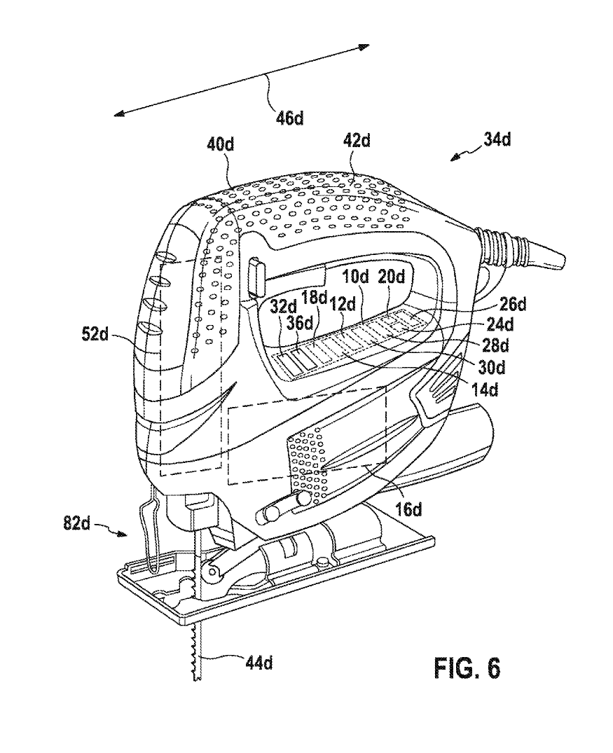

FIG. 6 shows a power tool 34d with at least one power tool device 10d. The power tool 34d is formed as a portable power tool. Here, the power tool 34d is formed as a jigsaw. The power tool 34d has a power tool housing 40d, which encloses a drive unit 16d of the power tool 34d and an output unit 52d of the power tool 34d. The drive unit 16d and the output unit 52d are intended for driving in an oscillating manner a machining tool 44d clamped in a tool holder 82d of the power tool 34d. Here, the machining tool 44d is driven in an oscillating manner substantially perpendicularly in relation to a machining direction. The machining tool 44d is formed as a jigsaw blade. It is however also conceivable that the machining tool 44d is formed by some other machining tool that appears appropriate to a person skilled in the art. An oscillating drive of the machining tool 44d takes place here in a way that is already known to a person skilled in the art.

By analogy with the power tool device 10a described in the description of FIGS. 1 to 3, the power tool device 10d comprises at least one machining tool sensor unit 28d, at least one operator sensor unit 18d, at least one workpiece sensor unit 30d, at least one power tool accessory sensor unit 26d, at least one ambient sensor unit 24d, at least one input unit 32d, at least one communication unit 20d and at least one information output unit 36d.

By means of the input unit 32d, an operating mode of the power tool 34d can be set. The power tool 34d has here at least an initial learning operating mode, a learning operating mode, a reference operating mode, a synchronization operating mode, a safety operating mode and/or an automatic operating mode. In the initial learning operating mode, a machining tool characteristic variable can be recorded by means of the machining tool sensor unit 28d. An oscillation of the machining tool 44d can be generated here as a result of activation of the drive unit 16d or of an additional actuator of the machining tool sensor unit 28d. The oscillation of the machining tool 44d can be recorded by means of a machining tool sensor element 70d, which is formed as an acceleration sensor, and can be evaluated by means of the open-loop and/or closed-loop control unit 12d. Consequently, for example, a defect or improper mounting of the machining tool 44d can be inferred.

A frequency of corrections to a cut that is to be made, which can be attributed to fatigue of an operator, can be recorded by means of an operator sensor element 68d of the operator sensor unit 18d. Consequently, a necessity for activation of the safety operating mode can be evaluated by means of the open-loop and/or closed-loop control unit 12d in dependence on the frequency of corrections. Moreover, characteristic variables of the ambient sensor unit 24d, of the power tool accessory sensor unit 26d, of the machining tool sensor unit 28d and/or of the workpiece sensor unit 30d can likewise be included for this purpose. With regard to further features of the power tool device 10d, reference may be made to the power tool device 10a described in the description of FIGS. 1 to 3.

1. A power tool device comprising:
at least one control unit, the at least one control unit being at least one of a closed-loop control unit and an open-loop control unit;
at least one drive unit sensor unit configured to record at least one drive unit characteristic variable, the at least one control unit being configured to process the at least one drive unit characteristic variable to at least one of: (i) control a drive unit of a power tool and (ii) provide an output of information to an operator of the power tool; and
at least one operator sensor unit configured to record at least one operator-specific characteristic variable, the at least one control unit being configured to process the at least one operator-specific characteristic variable to at least one of: (i) control the drive unit of the power tool and (ii) provide an output of information to the operator of the power tool.

2. The power tool device as claimed in claim 1, further comprising:
at least one communication unit configured to communicate with at least one external unit and exchange electronic data with the at least one external unit to provide control of the drive unit.

3. The power tool device as claimed in claim 2, wherein the control unit is configured to access a central database using the communication unit, the central database being configured to store at least one of (i) a safety rule and (ii) an operating area rule, the control unit being configured to process the at least one of the safety rule and the operating rule to control the drive unit.

4. The power tool device as claimed in claim 1, wherein the control unit is configured to detect at least in dependence on the at least one operator-specific characteristic variable, an operation of the power tool that cannot be controlled by the operator.

5. The power tool device at least as claimed in claim 2, wherein the control unit is configured to output at least one emergency signal using the communication unit at least in dependence on the at least one operator-specific characteristic variable.

6. The power tool device as claimed in claim 1, wherein the control unit is configured to at least one of (i) control the drive unit and (ii) output an item of information at least in dependence on the operator-specific characteristic variable formed as operator exposure to stress.

7. The power tool device as claimed in claim 1, wherein the control unit is configured to process an output of at least one ambient sensor unit to record at least one ambient characteristic variable, the at least one control unit being configured to process the at least one ambient characteristic variable to at least one of: (i) control a drive unit of the power tool and (ii) provide an output of information to the operator of the power tool.

8. The power tool device as claimed in claim 6, wherein the control unit is configured to adapt at least one parameter stored in a memory unit of the control unit to control the drive unit at least in dependence on at least one ambient characteristic variable recorded with of an ambient sensor unit and formed as a global position.

9. The power tool device as claimed in claim 1, further comprising:
at least one power tool accessory sensor unit configured to record at least one power tool accessory characteristic variable, the at least one control unit being configured to process the at least one power tool accessory characteristic variable to at least one of: (i) control a drive unit of the power tool and (ii) provide an output of information to the operator of the power tool.

10. The power tool device as claimed in claim 1, further comprising:
at least one machining tool sensor unit configured to record at least one machining tool characteristic variable, the at least one control unit being configured to process the at least one machining tool characteristic variable to at least one of: (i) control a drive unit of the power tool and (ii) provide an output of information to the operator of the power tool.

11. The power tool device as claimed in claim 1, further comprising:
at least one workpiece sensor unit configured to record at least one workpiece characteristic variable, the at least one control unit being configured to process the at least one workpiece characteristic variable to at least one of: (i) control a drive unit of the power tool and (ii) provide an output of information to the operator of the power tool.

12. The power tool device as claimed in claim 10, wherein, in at least one operating mode, the control unit is configured to control the drive unit in dependence on at least one workpiece characteristic variable that is recorded with of the workpiece sensor unit and defines an object that is located in a workpiece.

13. The power tool device as claimed in claim 1, wherein the drive unit sensor unit is configured to record the at least one drive unit characteristic variable formed as at least one of a ventilation characteristic variable and an operator risk characteristic variable.

14. The power tool device as claimed in claim 1, wherein the power tool device is included in a portable power tool.

15. A power tool system comprising:
a power tool having a power tool device, the power tool device comprising:
at least one control unit, the at least one control unit being at least one of a closed-loop control unit and an open-loop control unit;
at least one drive unit sensor unit configured to record at least one drive unit characteristic variable, the at least one control unit being configured to process the at least one drive unit characteristic variable to at least one of: (i) control a drive unit of the power tool and (ii) provide an output of information to an operator of the power tool; and
at least one operator sensor unit configured to record at least one operator-specific characteristic variable, the at least one control unit being configured to process the at least one operator-specific characteristic variable to at least one of: (i) control the drive unit of the power tool and (ii) provide an output of information to the operator of a power tool; and
an external sensor unit.

16. A method for controlling at least one power tool in at least one of an open-loop manner and a closed-loop manner, the at least one power tool having a power tool device comprising (i) at least one control unit, the at least one control unit being at least one of a closed-loop control unit and an open-loop control unit, (ii) at least one drive unit sensor unit configured to record at least one drive unit characteristic variable, the at least one control unit being configured to process the at least one drive unit characteristic variable to at least one of control a drive unit of the power tool and provide an output of information to an operator of the power too, and (iii) at least one operator sensor unit configured to record at least one operator-specific characteristic variable, the at least one control unit being configured to process the at least one operator-specific characteristic variable to at least one of control the drive unit of the power tool and provide an output of information to the operator of a power tool, the method comprising:
determining, with the control unit at least one operator state; and
at least one of:
outputting the operator state using of an information output unit;
providing at least one of open-loop and closed-loop control of the drive unit; and
providing at least one safety function of the power tool.

17. The method as claimed in claim 16, further comprising:
accessing, in at least one operating mode, with the control unit at least partially automatically using of a communication unit a central database, the central database being configured to store at least one of (i) a safety rule and (ii) an operating area rule, the control unit being configured to process the at least one of the safety rule and the operating rule to control the drive unit.

18. The method as claimed in claim 16, further comprising:
using, with the control unit, at least one of data recorded by a power tool sensor and data transmitted by a communication unit to provide the at least one of open-loop and closed-loop control of the drive unit.

19. The method as claimed in claim 16, further comprising:
outputting, with the control unit, at least one item of information using of an information output unit in dependence on at least one of data recorded by a power tool sensor and data transmitted by a communication unit.

20. The method as claimed in claim 16, further comprising:
controlling, with the control unit, at least one operating mode setting of the power tool in dependence on at least one of data recorded by a power tool sensor and data transmitted by a communication unit.
